(19) United States
(12) Patent Application Publication
(10) Pub. No.: US 2009/0133539 A1
(43) Pub. Date: May 28, 2009

(54) RATCHET WHEEL OF WRENCHES

(76) Inventor: Chin-Shun Cheng, Taichung County (TW)

Correspondence Address: Chin-Shun Cheng, No.37-2, Ching-Dau 1st Street, Taichung, 40464, TW

(21) Appl. No.: 12/365,903

(22) Filed: Feb. 5, 2009

Related U.S. Application Data
(63) Continuation-in-part of application No. 11/761,369, filed on Jun. 12, 2007, now abandoned.

(51) Int. Cl. B25B 13/46

(52) U.S. Cl. 81/63.1

(57) ABSTRACT

The present invention discloses a ratchet wheel of wrenches, the structure of the ratchet wheel has a penetrating hole consisting of two adjacent receiving holes having internal diameters differing from each other, each internal periphery has six forefront surfaces, six grooves and six concavities, the concavities and the grooves are disposed annularly in an interlaced order that are capable of containing flanges of a gear-shape workpiece, and the forefront surfaces are capable of latching the edges of a hexagonal workpiece. Whereby, each receiving hole can respectively accommodate, latch and drive several kind of workpieces with different size, and prevent workpieces from passing through the wrench randomly

### RELATED APPLICATION

This application is a Continuation-in-Part of U.S. application Ser. No. 11/761,369, entitled “A RATCHET WHEEL OF A WRENCH”, naming Chin-Shun Cheng as inventor, and filed on Jun. 12, 2007.

### FIELD OF THE INVENTION

This invention relates to a ratchet wheel of wrenches, and more particularly to a ratchet wheel that is suitable of being used for various workpieces in multiple specifications, and able to prevent the workpieces from passing through thereof randomly.

### BACKGROUND OF THE INVENTION

A conventional ratchet wheel of wrenches, such as the present inventor's U.S. Pat. No. 7,024,967, which can not prevent the workpiece taking off randomly from the ratchet wheel. A conventional ratchet wheel 60 as shown in FIG. 15 has an outer periphery provided with a plurality of engaging teeth 62 and an inner periphery with twelve V-shaped grooves 61, which can only fit a hexagonal or dodecagonal workpiece. A conventional structure of wrench, such as Ling et al. U.S. Patent application with publication No. 2001/0054334 and Hsieh's U.S. Patent application with publication No. 2004/0255728, which can not fit gear-shaped and E-shaped workpiece, and more different size of workpiece. And a conventional wrench, such as the present inventor's DE 20 2004 007 232, which can not fit more different size of workpiece. Further, a conventional structure of wrench, such as U.S. Pat. No. 5,983,758, as shown in FIG. 16, has a handle 71 extending out integrally from one side of an annular driving head 70 that is internally equipped with twelve equidistant and continuous V-shaped grooves 72 with the same shape, six of the twelve equidistant V-shaped grooves 72 have each a stop part 73 on one end such that the six grooves 72 are not through. When the driving head 70 is engaged with a workpiece, top of a workpiece would be limited by the stop part 73 and then efficacy of preventing the workpiece taking off randomly from the wrench would be achieved. However, the conventional wrench aforementioned has the shortcoming as follows.

General workpieces have various shapes, such as gear-shaped, E-shaped, triangle, quadrangle, hexagon, etc. The conventional ratchet wheel and driving head aforementioned has twelve V-shaped grooves, which can only fit hexagonal or dodecagonal workpiece but not gear-shaped and E-shaped workpiece, and they only fit one size of workpiece. Therefore, the conventional ratchet wheel and driving head is suitable for limited various workpieces so as to cause a shortcoming of inconvenience in use.

### SUMMARY OF THE INVENTION

The main objective of the present invention is to provide a ratchet wheel of a wrench that is suitable of being used for various workpieces, and for preventing the workpieces from passing through the ratchet wheel of the wrench randomly. The structure of the ratchet wheel has a penetrating hole consisting of two adjacent receiving holes having internal diameters differing from each other, each receiving hole has six forefront surfaces, six grooves and six concavities, the concavities and the grooves are disposed annularly in an interlaced order that are capable of containing flanges of a gear-shape workpiece, and the forefront surfaces are capable of latching the edges of a hexagonal workpiece. Whereby, each receiving hole can respectively accommodate, latch and drive several workpieces with different size, and prevent workpieces from passing through the wrench randomly.

The present invention will become more obvious from the following description when taken in connection with the accompanying drawings that show, for purposes of illustration only, a preferred embodiment in accordance with the present invention.

### BRIEF DESCRIPTION OF THE DRAWINGS

FIG. 1 is a perspective view of the wrench of the present invention;

FIG. 2 is a top view of the wrench of the present invention;

FIG. 3 is a perspective view of latching a gear-shaped workpiece of the present invention;

FIG. 4 is a top view of latching a gear-shaped workpiece of the present invention;

FIG. 5 is a perspective view of latching an E-shaped workpiece of the present invention;

FIG. 6 is a top view of latching an E-shaped workpiece of the present invention;

FIG. 7 is a side view of ratchet wheel of the present invention;

FIG. 8 is a top view of latching small hexagonal workpiece of the present invention;

FIG. 9 is a top view of latching big hexagonal workpiece of the present invention;

FIG. 10 is a perspective view of 2nd embodiment of the present invention;

FIG. 11 is a top view of 2nd embodiment of the present invention;

FIG. 12 is a perspective view of latching hexagonal workpiece of the present invention;

FIG. 13 is a top view of latching hexagonal workpiece of the present invention;

FIG. 14 is a cross-sectional view of latching hexagonal workpiece of the present invention;

FIG. 15 is a perspective view of a ratchet wheel of the prior art; and

FIG. 16 is a perspective view of a wrench of the prior art.

### DETAILED DESCRIPTION OF THE PREFERRED EMBODIMENT

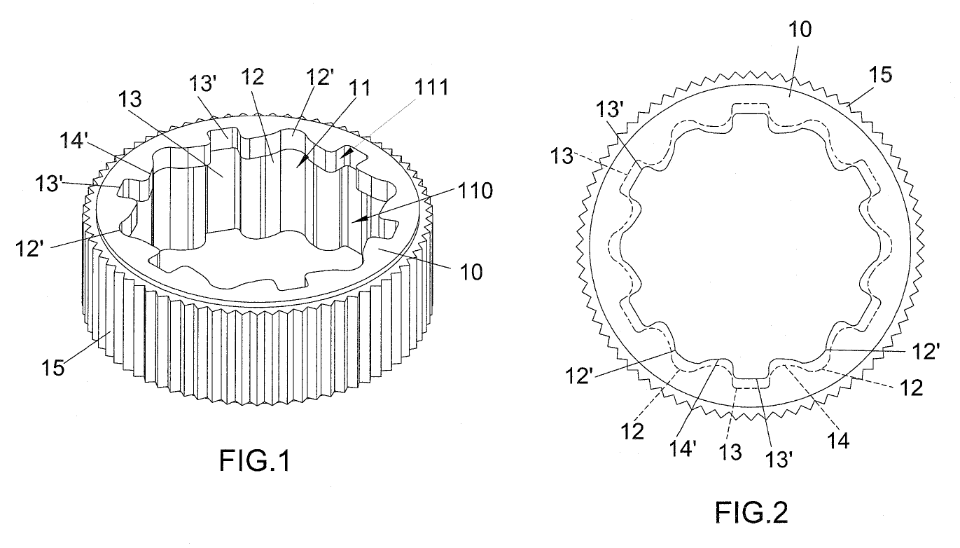

As shown in FIGS. 1 and 2, a basic structure of a ratchet wheel of a wrench of the present invention comprises a ratchet wheel 10. The ratchet wheel 10 is annular and has an outer periphery provided with plurality engaging teeth 15, and has a first end and a second end in opposite directions, and a central longitudinal axis that extends to connect the first end and the second end. At least one said end of the ratchet wheel 10 is equipped with a penetrating hole 11 extending along the central longitudinal axis, wherein the penetrating hole 11 consist of two adjacent receiving holes 110, 111 having internal diameters differing from each other, the shapes of the internal periphery of the two receiving holes 110, 111 viewed in a transversal cross section are similar. Each internal periphery has six grooves 12, 12′ that are distributed equidistantly therearound, the extending directions of the grooves 12, 12′ are parallel to the central longitudinal axis, a portion connecting each two adjacent grooves forms a forefront surface 14, 14′, the forefront surfaces 14, 14′ are projecting toward the central longitudinal axis, a concavity 13, 13′ is protruded from the middle of each forefront surface 14, 14′ and the extending direction of the concavity 13, 13′ is parallel to the central longitudinal axis, the shapes of the concavities 13, 13′ and the grooves 12, 12′ are different, and the concavities 13, 13′ and the grooves 12, 12′ are disposed annularly in an interlaced order, the concavities 13, 13′ and the grooves 12, 12′ are capable of containing flanges of a gear-shape workpiece. Whereby, each receiving holes 110, 111 can respectively accommodate and drive several workpieces with different size; and when the workpiece suitably latched and driven by big receiving holes 110 is inserted into the receiving holes 110, which can be blocked by the wall of the small receiving holes 111.

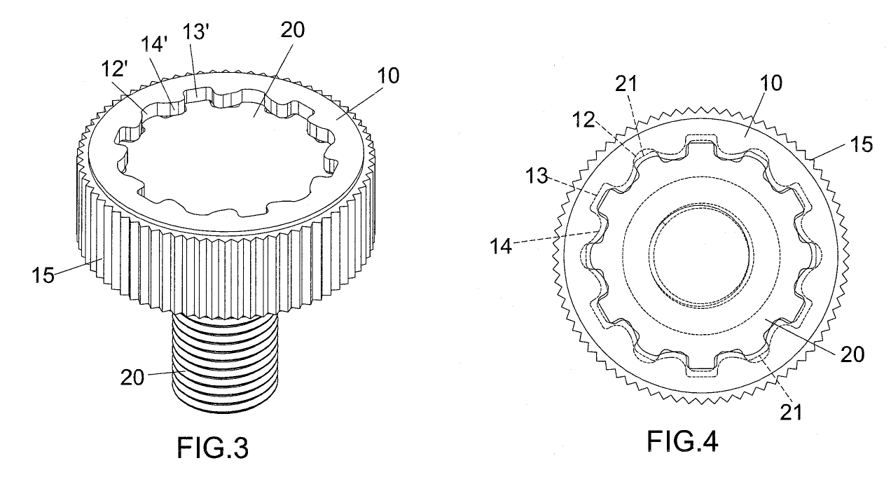

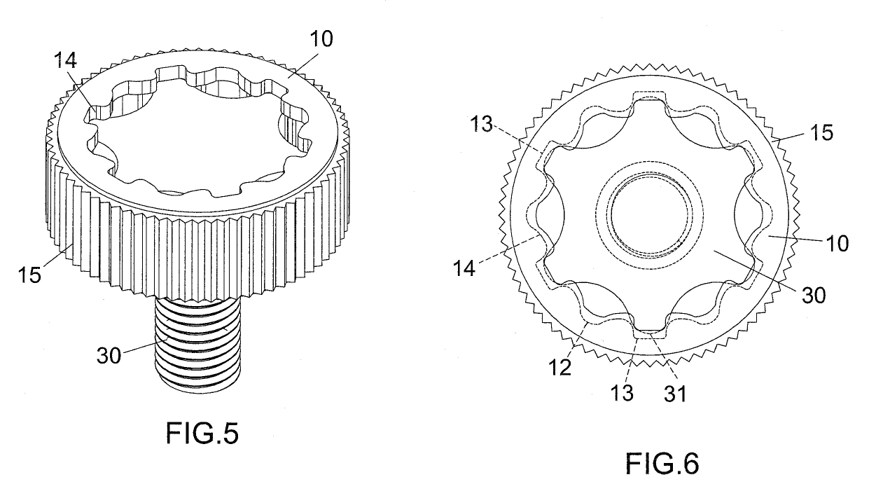

As shown in FIG. 2, the number of the forefront surfaces 14, 14′ and the grooves 12, 12′ each are six, which are disposed annularly in an interlaced order. The forefront surfaces 14, 14′ may be a curved surface projecting toward the central longitudinal axis. The grooves 12, 12′ and the forefront surfaces 14, 14′ each are in the form of curved surfaces, and the junction of the two curved surfaces is tangent to each other. The number of the concavity 13, 13′ is six and the size of the concavity 13, 13′ is big enough to accommodate a flange 21 of a gear-shaped workpiece 20 (as shown in FIGS. 3 and 4), or a flange 31 of an E-shaped workpiece 30 with six encircling flanges 31 (as shown in FIGS. 5 and 6).

Moreover, in the embodiment of FIGS. 1 and 2, the concavity 13 includes two opposite lateral side surfaces 130, 131 and a bottom edge 132, in which two opposite lateral side surfaces 130, 131 of the concavity 13 are parallel to each other, and the bottom edge 132 is a flat surface.

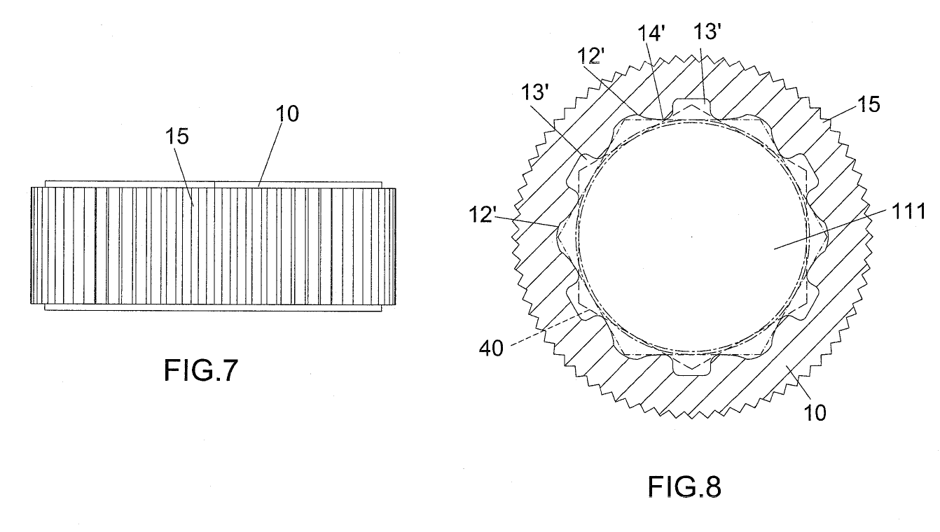

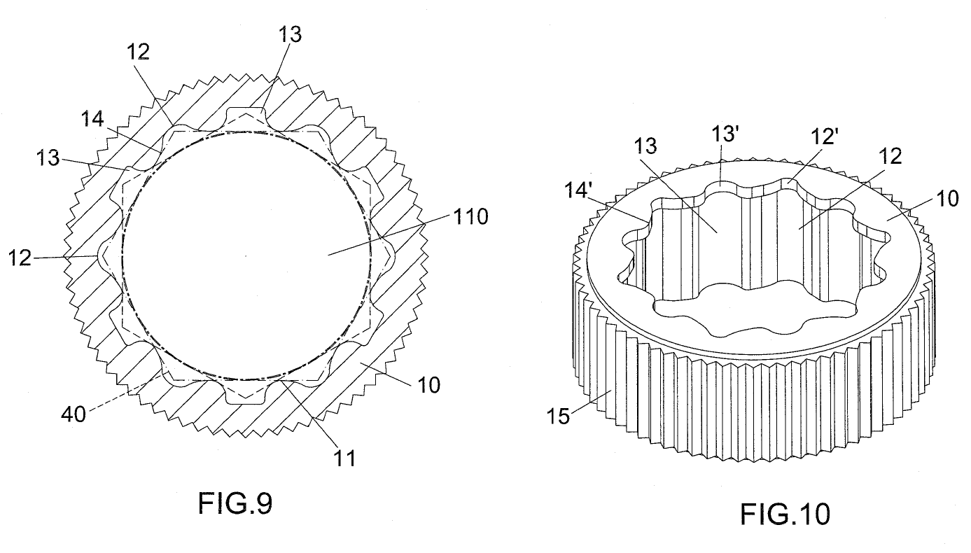

Referring to FIGS. 7 to 9, when the ratchet wheel 10 of the present invention accommodates a hexagonal workpiece 40 with six edges, the forefront surfaces 14, 14′ of the ratchet wheel 10 can latches the six edges of the hexagonal workpiece 40, and the grooves 12, 12′ and the concavity 13, 13′ can receive the corners of hexagonal workpiece 40. Referring to FIG. 8, the small receiving hole 111 can accommodate and latch a hexagonal workpiece with small size of metric unit and imperial unit, a gear-shaped workpiece or an E-shaped workpiece with small size. Referring to FIG. 9, the big receiving hole 110 can accommodate and latch a hexagonal workpiece with big size of metric unit and imperial unit, a gear-shaped workpiece or an E-shaped workpiece with big size.

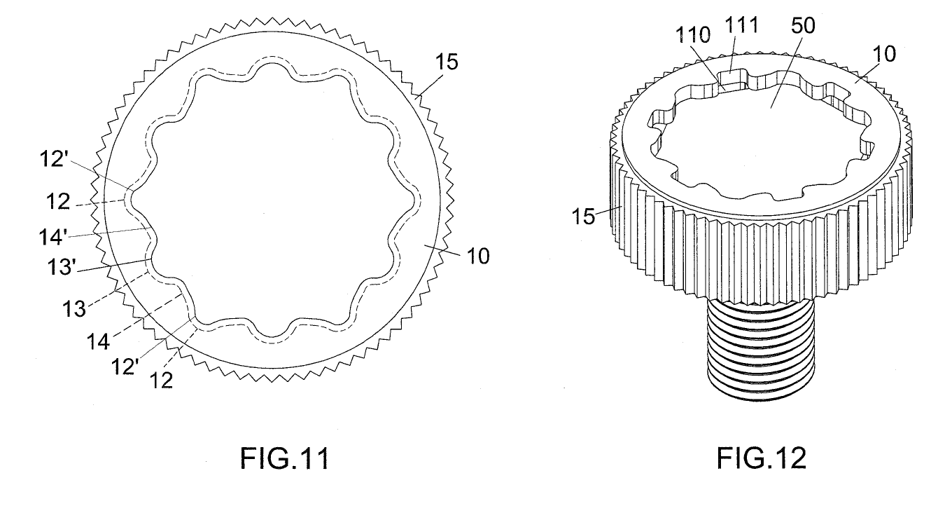

In the embodiment shown in FIGS. 10 and 11, each concavity 13, 13′ is a round arc surface also for receiving the flange of a gear-shaped workpiece or an E-shaped workpiece.

As shown in FIGS. 3 and 4, when big receiving hole 110 of the ratchet wheel 10 accommodates and latches a gear-shaped workpiece 20 with twelve flanges 21, the flanges 21 are accommodated within the grooves 12, 12′ and concavities 13, 13′, and the top portions of the flanges 21 are touched and blocked by the wall of the small receiving hole 111, thus to prevent the gear-shaped workpiece 20 from passing through the penetrating hole 11 of the ratchet wheel 10.

As shown in FIGS. 5 and 6, when big receiving hole 110 of the ratchet wheel 10 accommodates and latches an E-shaped workpiece 30 with six flanges 31, the flanges 31 are accommodated within the grooves 12, 12′ or concavities 13, 13′, and the top portions of the flanges 31 are touched and blocked by the wall of the small receiving hole 111, thus to prevent the gear-shaped workpiece 20 from passing through the penetrating hole 11 of the ratchet wheel 10.

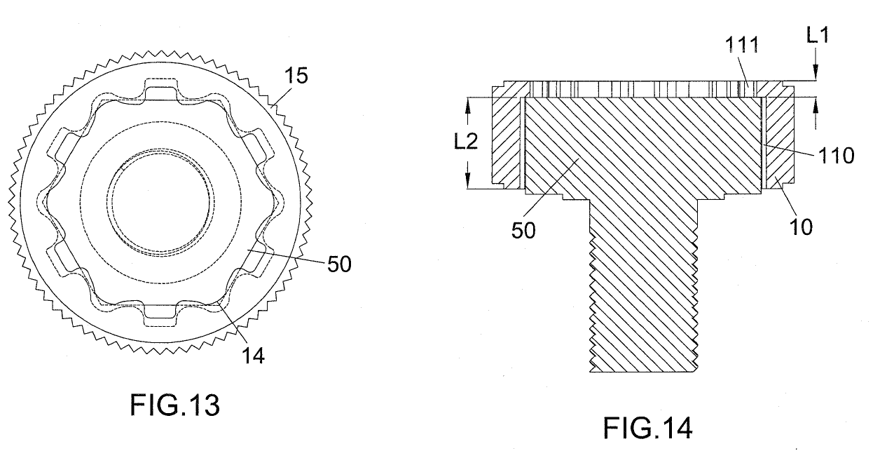

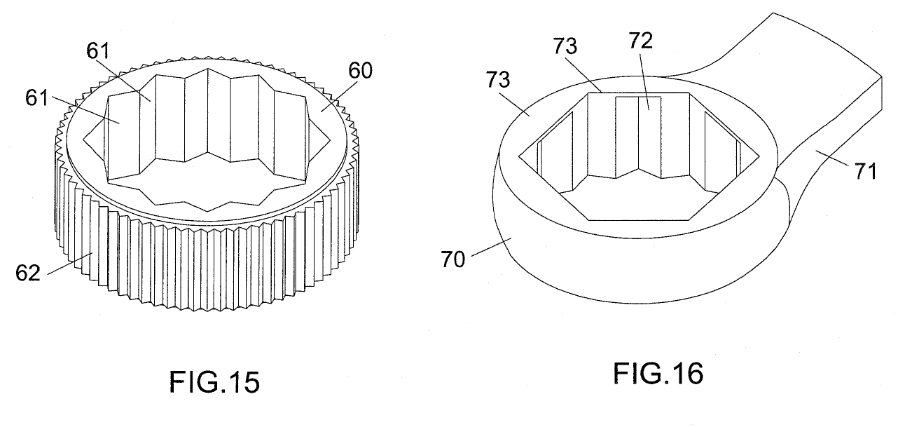

As shown in FIGS. 12 to 14, another embodiment of the present invention, the ratio of the length L1/L2 along the central longitudinal axis between small receiving hole 111 and big receiving hole 110 is less than ¼, so that the big receiving hole 110 can accommodate and latch a workpiece 50 effectively.

While we have shown and described the embodiment in accordance with the present invention, it should be clear to those skilled in the art that further embodiments may be made without departing from the scope of the present invention.

What is claimed is:

1. A ratchet wheel of wrenches having an outer periphery provided with a plurality of engaging teeth, which has a first end and a second end in opposite directions, and a penetrating hole having a central longitudinal axis extending from the first end to the second end, wherein the penetrating hole includes a small and a big receiving holes having internal diameters differing from each other, the shapes of the internal periphery of the two receiving holes viewed in a transversal cross section are similar, each internal periphery has six grooves that are distributed equidistantly therearound, the extending directions of the grooves are parallel to the central longitudinal axis, a portion connecting each two adjacent grooves forms a forefront surface, the forefront surfaces are projecting toward the central longitudinal axis, a concavity is protruded from the middle of each forefront surface and the extending direction of the concavity is parallel to the central longitudinal axis, the shapes of the concavities and the grooves are different, and the concavities and the grooves are disposed annularly in an interlaced order, the concavities and the grooves are capable of containing flanges of a gear-shape workpiece.

2. The ratchet wheel as claimed in claim 1, wherein each groove and each forefront surfaces are in the form of curved surface and a junction of two adjacent curved surfaces is tangent to each other.

3. The ratchet wheel as claimed in claim 1, wherein the concavity includes two opposite lateral side surfaces and a bottom edge.

4. The wrench as claimed in claim 3, wherein said two opposite lateral side surfaces of the concavity are parallel.

5. The ratchet wheel as claimed in claim 3, wherein the bottom edge of the concavity is an arc surface.

6. The ratchet wheel as claimed in claim 3, wherein the bottom edge of the concavity is a flat surface.

7. The ratchet wheel as claimed in claim 1, wherein the concavity is a round arc surface.

8. The ratchet wheel as claimed in claim 1, wherein a ratio of the length along the central longitudinal axis between the small receiving hole and the big receiving hole is less than ¼.

9. A ratchet wheel of wrenches having an outer periphery provided with a plurality of engaging teeth, which has a first end and a second end in opposite directions, and a penetrating hole having a central longitudinal axis extending from the first end to the second end, wherein the penetrating hole is formed by a small and a big receiving holes having internal diameters differing from each other, each internal periphery has six grooves that are distributed equidistantly therearound, the extending directions of the grooves are parallel to the central longitudinal axis, a portion connecting each two adjacent grooves forms a forefront surface, the forefront surfaces are projecting toward the central longitudinal axis, a concavity is protruded from the middle of each forefront surface and the extending direction of the concavity is parallel to the central longitudinal axis, the shapes of the concavities and the grooves are different, and the concavities and the grooves are disposed annularly in an interlaced order, the concavities and the grooves are capable of containing flanges of a gear-shape workpiece, and the small receiving hole can accommodate and latch a hexagonal workpiece with small size of metric unit and imperial unit, a gear-shaped workpiece or an E-shaped workpiece with small size, the big receiving hole can accommodate and latch a hexagonal workpiece with big size of metric unit and imperial unit, a gear-shaped workpiece or an E-shaped workpiece with big size.

10. The ratchet wheel as claimed in claim 9, wherein a ratio of the length along the central longitudinal axis between the small receiving hole and the big receiving hole is less than ¼.
